(19) United States
(12) Patent Application Publication
(10) Pub. No.: US 2023/0137661 A1
(43) Pub. Date: May 4, 2023

(54) VERIFICATION METHOD AND VERIFICATION SYSTEM FOR INFORMATION AND COMMUNICATION SAFETY PROTECTION MECHANISM

(71) Applicant: INSTITUTE FOR INFORMATION INDUSTRY, Taipei City (TW)

(72) Inventors: CHAO-WEN LI, TAIPEI CITY (TW); CHING-HAO MAO, TAIPEI CITY (TW); WEN-YA LIN, TAIPEI CITY (TW); WEN-HSI TU, TAIPEI CITY (TW)

(21) Appl. No.: 17/535,656

(22) Filed: Nov. 25, 2021

(30) Foreign Application Priority Data
Nov. 2, 2021 (TW) 110140707

(51) Int. Cl. G06F 21/57; G06F 21/53

(52) U.S. Cl. CPC G06F 21/577; G06F 21/53; G06F 2221/034

(57) ABSTRACT

A verification method and a verification system for an information and communication safety protection mechanism are provided. The verification methods includes: selecting a target malicious program, and collecting at least one behavioral trace of the target malicious program; providing a target machine and deploying a protection mechanism to be tested for the target machine; configuring the target machine to reproduce the at least one behavioral trace; and determining whether the protection mechanism to be tested detects an abnormal event, so as to verify an effectiveness of the protection mechanism to be tested.

### CROSS-REFERENCE TO RELATED PATENT APPLICATION

This application claims the benefit of priority to Taiwan Patent Application No. 110140707, filed on Nov. 2, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a verification method and a verification system, and more particularly to a verification method and a verification system for an information and communication security protection mechanism.

### BACKGROUND OF THE DISCLOSURE

At present, in order to perform security effectiveness tests for a personal computer and an information security protection mechanism thereof, real vulnerabilities and executions of real malicious programs on an apparatus to be tested are necessary. A little carelessness may cause critical information security incidents, and result in actual damages to the apparatus to be tested. For example, data availability or system integrity of the apparatus to be tested may be damaged.

The existing information security effectiveness test contains three elements: a malicious program that launches attacks, a security mechanism, and an information and communication apparatus that has vulnerabilities. For example, the personal computer must have a real malicious program or that, in cooperation with real vulnerabilities. The real malicious program is used to obtain authorities for accessing memory, file system and network, and are then checked and killed by security protection mechanisms (such as endpoint detection and response (EDR)).

Since execution conditions of malicious programs are limited, statistics suggest that only half of the vulnerabilities can be reproduced for successfully executing the malicious programs.

### SUMMARY OF THE DISCLOSURE

In response to the above-referenced technical inadequacies, the present disclosure provides a verification method and a verification system for an information and communication security protection mechanism, so that an effectiveness of a protection mechanism can be verified without executing malicious programs or exploiting real system vulnerabilities.

In one aspect, the present disclosure provides a verification method for an information and communication security protection mechanism. The verification method includes: selecting a target malicious program, and collecting at least one behavioral trace of the target malicious program; providing a target machine and deploying a protection mechanism to be tested for the target machine; configuring the target machine to reproduce the at least one behavioral trace; and determining whether or not the protection mechanism to be tested detects an abnormal event, so as to verify an effectiveness of the protection mechanism to be tested.

In another aspect, the present disclosure provides a verification system for an information and communication security protection mechanism, the verification system includes a target machine that has a protection mechanism to be tested deployed therewith. The target machine is configured to verify a target malicious program that is selected. The target malicious program corresponds to at least one behavioral trace, and the target machine is configured to reproduce the at least one behavioral trace, and determine whether or not the protection mechanism to be tested detects an abnormal event, so as to verify an effectiveness of the protection mechanism to be tested.

Therefore, the verification method and the verification system for the information and communication security protection mechanism provided by the present disclosure can verify an effectiveness of a protection mechanism without executing malicious programs, and without using real system vulnerabilities. In other words, since real vulnerabilities are not used to actually execute the malicious programs, there is no actual damage, such as damage to data availability or system integrity.

In addition, compared with the existing information and communication security testing method that requires three elements, i.e., a subject that launches attacks, a target machine that has vulnerabilities, and a protection mechanism, the verification method and verification system for the information and communication safety protection mechanism of the present disclosure only need two elements, namely a target machine and a protection mechanism, for achieving an effectiveness verification and an evaluation of the protection mechanism.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIGS. 1A and 1B are respectively a first schematic diagram and a second schematic diagram of a verification system for an information and communication security protection mechanism according to one embodiment of the present disclosure;

FIG. 2 is a flowchart of a verification method for an information and communication security protection mechanism according to one embodiment of the present disclosure;

FIG. 3 is a block diagram of a first computer apparatus according to one embodiment of the present disclosure;

FIG. 4 is a block diagram of a second computer apparatus according to one embodiment of the present disclosure; and

FIG. 5 is a block diagram of a virtual machine according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

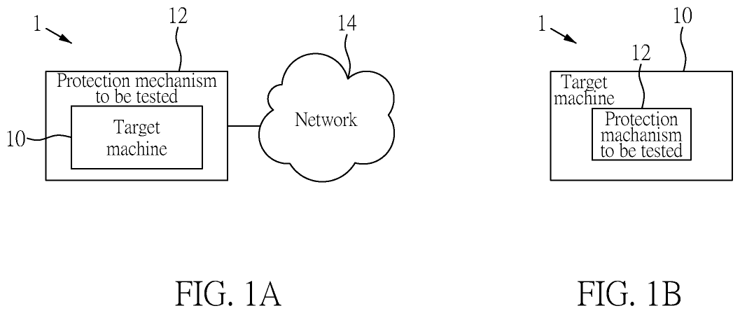

FIGS. 1A and 1B are respectively a first schematic diagram and a second schematic diagram of a verification system for an information and communication security protection mechanism according to one embodiment of the present disclosure; Referring to FIGS. 1A and 1B, a first embodiment of the present disclosure provides a verification system 1 for an information and communication security protection mechanism, and the verification system 1 includes a target machine 10 that is deployed with a protection mechanism to be tested 12.

It should be noted that the protection mechanism to be tested 12 can be deployed at a specific location based on characteristics of the protection mechanism to be tested 12. In some embodiments, the protection mechanism to be tested 12 can be, for example, a firewall or an email protection apparatus, which is set around an outside of the target machine 10 as shown in FIG. 1A, and so-called “setting around the outside” refers to setting between the target machine 10 and a network 14. The firewall can, for example, issue a warning to notify the user that an abnormal event occurs in response to the target machine 10 generating a sign that violates firewall rules, and the email protection apparatus can issue a warning to notify the user that an abnormal event occurs in response to the target machine 10 produces a sign that violates email protection mechanism.

In other embodiments, the protection mechanism to be tested 12 can be, for example, an endpoint protection apparatus, which is set inside the target machine 10 as shown in FIG. 1B, and can be, for example, an endpoint detection and response (EDR) system that can detect, investigate, and respond to malicious programs. The EDR system can issue a warning to notify the user that an abnormal event occurs in response to the target machine 10 generating a sign or a trace that are related to an endpoint protection being infected.

In the existing verification method, the personal computer must have a real malicious program or that, with real vulnerabilities, which are used to obtain authorities for accessing memory, file system and network permissions, and are then checked and killed by a security protection mechanism (such as the EDR). However, since an execution condition of the malicious program may be too stringent when it is designed, therefore, it is extremely time-consuming and cost-intensive to reproduce an operating system environment with proper execution conditions regardless of being implemented by a hardware or a virtual machine.

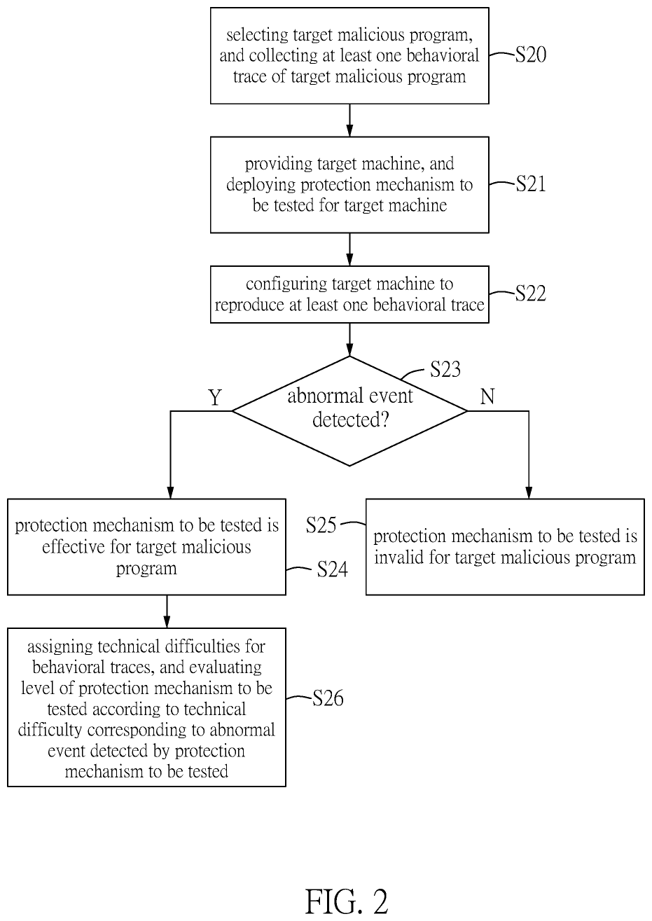

Therefore, one embodiment of the present disclosure provides a verification method for the information and communication security protection mechanism, which is suitable for the verification system 1 described above. Reference is made to FIG. 2, which is a flowchart of a verification method for an information and communication security protection mechanism according to one embodiment of the present disclosure.

As shown in FIG. 2, the verification method can include the following steps:

Step S20: selecting a target malicious program, and collecting at least one behavioral trace of the target malicious program. In this step, a purpose of collecting the behavioral trace is to reproduce, in subsequent steps, the same technical details in the target machine as those of the target machine being hacked. Therefore, after the behavioral traces are collected, types of behavioral traces can be determined based on locations of the behavioral traces. In one embodiment of the present disclosure, there are three types of behavioral traces based on the locations of the behavioral traces, including memory traces, file system traces, and network connection traces. If one of the three behavioral traces appears in the target machine, the target machine is taken as having been invaded by malicious programs, and the protection mechanism should be able to protect or detect.

For further example, the memory trace can include memory-type vulnerabilities or common behaviors of malicious programs, such as arbitrarily modifying data structure in a memory of the target machine, adding new memory sections, and the like. For example, if a read-write flag of one memory block in the target machine is changed from read-only to executable (exec), or common malicious mutex value is injected into the memory of the target machine, these kinds of malicious memory-type behaviors obviously belong to the memory traces.

The file system trace can be, for example, undesirable effects on the file system caused by arbitrarily adding, modifying, and deleting files (including logs and system configuration files) in the file system. For example, files in the target machine are encrypted and a ransomware text file is generated on a desktop of an operating system, or a link file that is not dynamically linked by other normal programs is added to the file system, such malicious actions directed at the file system are taken as the file system traces.

The network connection traces can be unauthorized and unknown network behaviors, such as sending data to the outside (network) through a network interface, enabling a communication port to wait for a connection, or the like. For example, the target machine may request to connect to an external relay station, to transmit a large amount of plaintext data, to inject the relay station connection record into the memory, or insert a blacklisted URL in a browser history record, these malicious network behaviors are taken as the network connection traces.

AppleJeus malware is taken as the target malware in an example for further illustrations hereinafter, and behavioral traces of AppleJeus can include:

Behavior 1: installing Updater.exe in folder C:\Program Files (x86)\CelasTradePro;

Behavior 2: connecting to relay station 196.38.48.121;

Behavior 3: connecting to relay station 185.142.236.226;

Behavior 4: collecting victim's process lists through “tasklist” command;

Behavior 5: collecting specific registry files through “reg query” command, such as a key value of HKLM\SOFTWARE\Microsoft\Window NT\Current Version;

Trace 1: residual file celastradepro_win_installer_1.00.00.msi (its MD5 check code is 9e740241ca2acdc79f30ad2c3f50990a);

Trace 2: residual file Updater.exe (b054a7382adf6b774b15f52d971f3 799);

Trace 3: residual log, Windows Security Log Event ID 4738: Installer requires the victim to provide an administrative permission to execute;

Trace 4: memory remains, String_ABOUT_QT_BITCOIN_TRADER_TEXT=Celas Trade Pro is a free Open Source project developed on pure C++ Qt and OpenSSL;

Relic 5: memory remains, fake connection string User-Agent string “Mozilla/5.0 (compatible; MSIE 10.0; Windows NT 6.1; Trident/6.0”;

Behavior 1 occupies memory blocks, behaviors 2, 3, 4, 5, and trace 4 leave memory strings, therefore, they can all be classified as the memory traces. Since traces 1, 2 and 3 leave files and logs that occupy disk blocks, they can be classified as the file system traces. It should be noted that the behavioral traces are classified to help recreating behavioral traces in subsequent steps.

Step S21: providing a target machine, and deploying a protection mechanism to be tested for the target machine.

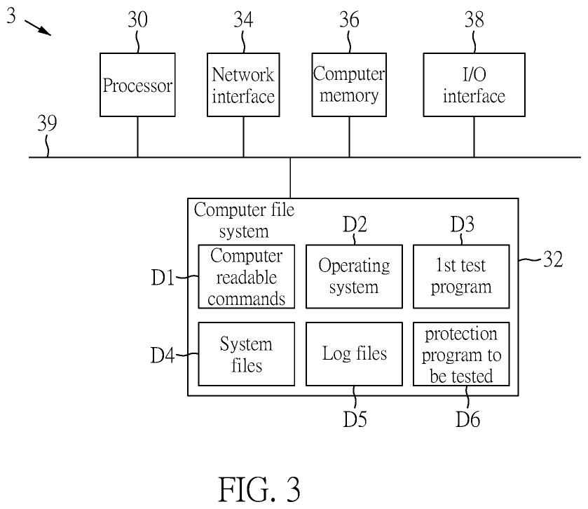

Reference is further made to FIG. 3, which is a block diagram of a first computer apparatus according to one embodiment of the present disclosure. Referring to FIG. 3, the target machine can be, for example, a first computer apparatus 3, which includes a processor 30, a computer file system 32, a network interface 34, a computer memory 36 and an input and output (I/O) interface 38. The above-mentioned components can communicate with each other through, for example, but not limited to, a bus 39.

The processor 30 is electrically coupled to the computer file system 32, and is configured to access computer readable commands D1 from the computer file system 32, so as to control the components in the first computer apparatus 3 to perform functions of the first computer apparatus 3.

The computer file system 32 can include any storage device used to store data, such as, but not limited to, a hard disk drive (HDD), a solid state drive (SSD), or other storage devices that can be used to store data. The computer file system 32 is configured to store at least a plurality of computer readable commands D1, an operating system D2, a first test program D3, system files D4, log files D5, and a protection program to be tested D6.

The network interface 34 is configured to access the network under control of the processor 30, and the network interface 34 can be, for example, a wired or wireless network card. The computer memory 36 can be, for example, but not limited to a random access memory (RAM), a read only memory (ROM), or a flash memory, which is configured to store data or instructions under control of the processor 30. The operating system D2 can be executed by the processor 30, and the computer memory 36 is used as a temporary data storage medium of the operating system D2 to provide an appropriate operating environment for executing the first test program D3 and the protection program to be tested D6 and accessing the computer memory 36, the system files D4 and log files D5. The protection program to be tested D6 can be executed by the processor 30 to deploy the protection mechanism to be tested in the first computer apparatus 3, but the present disclosure is not limited thereto. The first test program D3 is to be used to reproduce the behavioral traces of the target malicious program, which is explained in the subsequent steps.

The I/O interface 38 can be operated by a user to communicate with the processor 30 for data input and output. The input and output interface 38 can be connected to input or output devices such as a keyboard, a mouse, and a display.

In more detail, the verification method can be implemented by using a computer program to control the components of the first computer apparatus 3. The computer program can be stored in a non-transitory computer readable recording medium, such as a read-only memory, a flash memory, a floppy disk, a hard disk drive, an optical disk, a flash drive, a magnetic tape, a network accessible database or computer-readable recording medium with the same functions that can be easily realized by those skilled in the art.

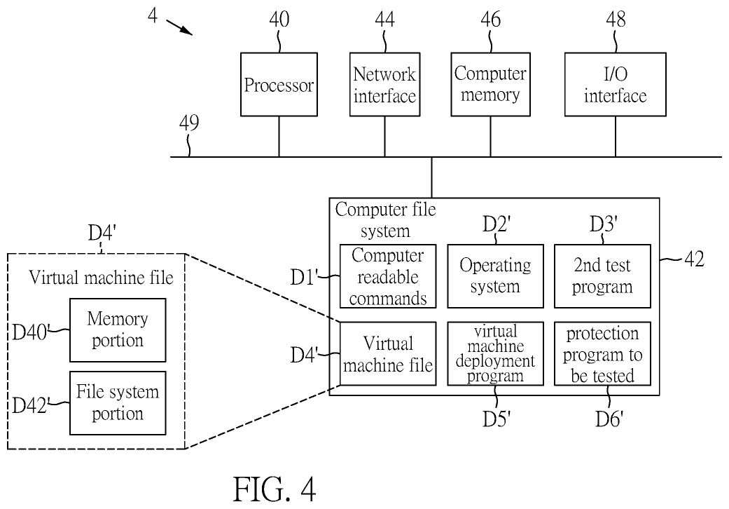

Reference is further made to FIG. 4, which is a block diagram of a second computer apparatus according to one embodiment of the present disclosure. Referring to FIG. 4, a second computer apparatus 4 is provided, which includes a processor 40, a computer file system 42, a network interface 44, a computer memory 46, and an I/O interface 48, and the components mentioned above can communicate with each other through a bus 49. The second computer apparatus 4 is similar to the first computer apparatus 3 of FIG. 3, and thus functions of each element are omitted hereinafter. It should be noted that the computer file system 42 is configured to store at least a plurality of computer readable commands D1′, an operating system D2′, a second test program D3′, a virtual machine file D4′, a virtual machine deployment program D5′ and a protection program to be tested D6′.

In the embodiment of FIG. 4, the target machine may be, for example, a virtual machine deployed by executing the virtual machine file D4′ through the second computer apparatus 4. For example, the processor 40 of the second computer apparatus 4 can execute the virtual machine deployment program D5′ to deploy a virtual machine as a target machine according to the virtual machine file D4′.

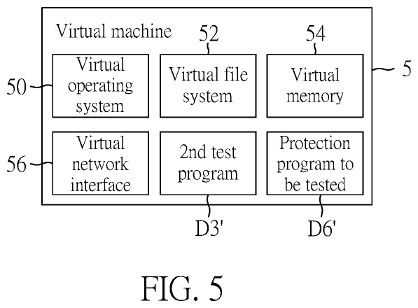

Reference is further made to FIG. 5, which is a block diagram of a virtual machine according to one embodiment of the present disclosure. As shown in FIG. 5, the virtual machine is a software computer that can execute an operating system and applications like a physical computer. The virtual machine is composed of a set of specifications and configuration files, and is supported by physical resources of a host. Each virtual machine has virtual devices that provide the same functions as physical hardware, but these devices are easier to carry, manage, and are more secure.

As shown in FIG. 5, the virtual machine 5 can be deployed to include a virtual operating system 50, a virtual file system 52, a virtual memory 54 and a virtual network interface 56, and a second test program D3′ and a protection program to be tested D6′ can be inserted into the virtual file system 53 from the computer file system 42 during the deployment of the virtual machine 5. After the deployment of the virtual machine 5 is completed, the protection program to be tested D6′ is executed by a virtual processor (not shown) to deploy the protection mechanism to be tested for the virtual machine 5, and FIG. 5 merely exemplarily shows these blocks. In addition, the virtual machine file D4′ can include a memory portion D40′ associated with the virtual memory 54 and a file system portion D42′ associated with the virtual file system 52.

Step S22: configuring the target machine to reproduce at least one behavioral trace.

For example, in an architecture of FIG. 3, the processor 30 of the first computer apparatus 3 can be configured to execute the first test program D3 to, according to the type of at least one behavioral trace, modify the computer memory 36 or the computer file system 323 of the first computer apparatus 3, or imitate the network connection trace through the network interface 34. In detail, the first test program D3 can be, for example, a software agent. The software agent can be located in the first computer apparatus 3 that serves as a target machine, and is taken as a core program with the highest authority. The software agent can also connect to the external Internet through the network (such as the network interface 34) of the target machine for data transmission. In addition, the first test program D3 can also be implemented in hardware or firmware to modify the content of the computer memory 36 or the computer file system 32.

Taking a compiler as an example, a part of the memory sections of the computer memory 36 can be allocated according to memory strings and locations left by the aforementioned behavior 2, behavior 3, behavior 4, behavior 5, and trace 4 to directly insert the strings corresponding to the behavioral traces. After the compilation is completed, the first test program D3 is executed, and the aforementioned behavior 2, behavior 3, behavior 4, behavior 5, and trace 4 can be reproduced. Alternatively, taking an interpreter as an example, network connections can be directly performed to implement connections between the target machine and the relay stations of behavior 2 and behavior 3, thereby reproducing the memory traces.

In addition, the first test program D3 can also be executed to modify the system file D4 and the log file D5 based on remaining files and logs of the aforementioned traces 1, 2 and 3, so as to add files and logs corresponding to the behavioral traces, such that the file system traces can be reproduced.

Further, for the architecture of FIG. 4, two manners can be used to reproduced the behavioral traces. One manner is similar to the manner described above for FIG. 3. In a deployment state of the virtual machine 5, the second test program D3′ is executed to, according to at least one behavioral trace and a location thereof, insert strings into the virtual memory 54, modify the virtual file system 52, or directly execute the connection behavior through the virtual network interface 56 to reproduce all the behavioral traces.

Another manner is to modify the virtual machine file D4′ in an offline state of the virtual machine 5 to reproduce the behavioral traces. In detail, a script can be written for the second test program D3′ to modify the memory portion D40′ or the file system portion D42′ of the virtual machine file D4′ in the offline state of the virtual machine 5 according to the type of at least one behavioral trace.

Taking the virtual machine deployment program that uses VMware as an example. If the memory traces are to be reproduced, *.VMEM file corresponding to the virtual memory can be firstly extracted from the virtual machine file in response to the virtual machine being in the offline state, and the strings corresponding to the aforementioned memory traces can be directly inserted in blank spaces to reproduce the memory traces with these strings after the virtual machine is deployed. Alternatively, a normal PROCESS program can be duplicated, and then a content of the PROCESS program can be modified to match to the network connection traces to be simulated. The modified PROCESS program can be inserted into the blank spaces of the *.VMEM file, such that after the virtual machine is deployed, the modified PROCESS program can be automatically loaded into the virtual memory to simulate the network connection traces.

Furthermore, if the file system traces are to be reproduced, a *.VMDK file corresponding to the virtual file system can be firstly extracted from the virtual machine file in response to the virtual machine being in the offline state. For files corresponding to the file system traces, a file table and blank sectors of the *.VMDK file can be directly modified. For logs corresponding to the file system traces, a *.EVTX file can be further extracted from the *.VMDK file and codes of the logs can be directly inserted into blank sectors.

It should be noted that the number of deployed virtual machines is not limited to the number described in the foregoing embodiment, and a user can deploy multiple virtual machines simultaneously according to computing capabilities of the computer equipment and requirements. Multiple virtual machines can not only be used to reproduce the network connection behavior from the outside to the inside, but also for different malicious programs or different behavioral traces of the same malicious program. The above verification methods can be executed by multitasking to speed up the verification process.

In addition, the following is another example to illustrate the way to reproduce the behavioral traces. AppleJeus malware is again taken as an example. When a current attack step of the AppleJeus malware is executed to a step that a user is installing AppleJeus malware, multiple behavioral traces are produced, for example, two virus images are unzipped in the file system and a log file “Log Event ID 4738” is left, specific strings of “Celas Trade Pro” are left and a mutex is inserted in the memory.

In order to imitate this attack step, “Expand” command can be executed to simulate the behavior of unzipping two virus images, System.Threading.Mutex call is executed to inject the mutex into the memory, and Start-Process-Verb RunAs a.exe command is executed to generate the log file “Log Event ID 4738”.

Therefore, through the above method, traces of hacking events that are artificially manufactured can be used to demonstrate a scene after the attack, which reduces the technical difficulty of establishing the scene. In addition, due to the high cost of creating an environment suitable for executions of malicious programs, the verification method provided by the present disclosure uses steps similar to malicious programs to imitate malicious program attacks with lesser damages than that of direct executions of malicious programs or even without damage, so as to test whether the protection mechanism to be tested can detect such malicious steps, thereby verifying an effectiveness of the protection mechanism. Therefore, the verification method provided by the present disclosure has high verification flexibility.

In addition, compared with the existing verification method that directly uses the virtual machine to test the malicious program, the verification system and the verification method of the present disclosure are less dependent on an environment of the operating system. For example, through the verification system and the verification method of the present disclosure, it is possible to imitate, in the new generation operating system, the traces of attacks directed to vulnerabilities of a previous generation of the operating system, without the need for the existence of real vulnerabilities. Since the dependency on the operating system environment is low, the verification system and the verification method of the present disclosure have high scalability.

Reference can be made to FIG. 2 again, the verification method proceeds to step S23: determining whether the protection mechanism to be tested detects an abnormal event.

Taking the first computer apparatus 3 in FIG. 3 as an example. After the first computer apparatus 3 is powered on, the first test program D3 (in a form of compiler and/or interpreter) is executed to confirm that the protection mechanism to be tested is deployed normally, and whether the protection mechanism to be tested detects an abnormal event can be determined as a result of the verification method.

Taking the virtual machine 5 in FIGS. 4 and 5 as an example, the second computer apparatus 4 can execute the virtual machine deployment program D5′ to deploy the virtual machine 5 and confirm that the protection mechanism to be tested is normally deployed in the virtual machine 5. Then, whether the protection mechanism detects an abnormal event can be determined as a result of the verification method.

In response to detecting the abnormal event in step S23, the verification method proceeds to step S24: determining that the protection mechanism to be tested is effective for the target malicious program. In response to no abnormal event being detected in step S23, the verification method proceeds to step S25: determining that the protection mechanism to be tested is invalid for the target malicious program.

Optionally, when the number of behavior traces of the target malicious program is plural, the verification method can proceed to step S26: assigning technical difficulties for multiple ones of the behavioral traces, and evaluating a level of the protection mechanism to be tested according to the technical difficulty corresponding to the abnormal event detected by the protection mechanism to be tested. For example, the simulated traces of the hacking events can be assigned with technical difficulties, and can be divided into types of file system, logs, memory strings, and memory blocks for analysis, thereby further exploring a limit of the protection mechanism to be tested.

### Beneficial Effects of the Embodiments

In conclusion, the verification method and the verification system for the information and communication security protection mechanism provided by the present disclosure can verify an effectiveness of a protection mechanism without executing malicious programs, and without using real system vulnerabilities. In other words, since real vulnerabilities are not used to actually execute the malicious programs, there is no actual damage, such as damage to data availability or system integrity.

In addition, compared with the existing information and communication security testing method that requires three elements of a subject that launches attacks, a target machine that has vulnerabilities and a protection mechanism, the verification method and verification system for the information and communication safety protection mechanism of the present disclosure only need two elements, namely a target machine and a protection mechanism, so as to achieve an effectiveness verification and an evaluation of the protection mechanism.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A verification method for an information and communication security protection mechanism, the verification method comprising:
selecting a target malicious program, and collecting at least one behavioral trace of the target malicious program;
providing a target machine and deploying a protection mechanism to be tested for the target machine;
configuring the target machine to reproduce the at least one behavioral trace; and
determining whether or not the protection mechanism to be tested detects an abnormal event, so as to verify an effectiveness of the protection mechanism to be tested.

2. The verification method according to claim 1, the step of collecting the at least one behavioral trace of the target malicious program further includes:
determining, according to a location of the at least one behavioral trace, whether a type of the at least one behavioral trace is a memory trace, a file system trace, or a network connection trace.

3. The verification method according to claim 2, wherein the target machine is a first computer apparatus, and the verification method further comprises configuring the first computer apparatus to execute a first test program to reproduce the at least one behavioral trace.

4. The verification method according to claim 3, wherein the step of configuring the target machine to reproduce the at least one behavioral trace further includes:
configuring the first computer apparatus to execute the first test program to modify a computer memory or a computer file system of the first computer apparatus according to the type of the at least one behavioral trace, or imitate the network connection trace by a network interface of the first computer apparatus.

5. The verification method according to claim 4, wherein the step of modifying the computer memory of the target machine includes configuring the first computer apparatus to execute the first test program to allocate a memory section according to the at least one behavioral trace and a location of the at least one behavioral trace, and insert strings corresponding to the at least one behavioral trace in the memory section.

6. The verification method according to claim 2, wherein the target machine is a virtual machine deployed by executing a virtual machine file through a second computer apparatus, and the step of reproducing the at least one behavioral trace in the target machine further includes modifying the virtual machine file in an offline state of the virtual machine to reproduce the at least one behavioral trace.

7. The verification method according to claim 6, wherein the virtual machine is deployed to include a virtual memory and a virtual file system, and the virtual machine file includes a memory portion associated with the virtual memory and a file system portion associated with the virtual file system.

8. The verification method according to claim 7, wherein the step of configuring the target machine to reproduce the at least one behavioral trace further includes:
configuring, according to the type of the at least one behavioral trace, the second computer apparatus to modify the memory portion or the file system portion of the virtual machine file in the offline state of the virtual machine, or to execute a test program in a deployed state of the virtual machine to imitate the network connection trace.

9. The verification method according to claim 1, wherein the protection mechanism to be tested is an endpoint protection apparatus, a firewall, or an email protection apparatus, and the step of deploying the protection mechanism to be tested for the target machine further includes setting the endpoint protection apparatus inside the target machine, setting the firewall outside the target machine, or setting the email protection apparatus outside the target machine.

10. The verification method according to claim 1, wherein a number of the at least one behavioral trace is plural, and the step of verifying the effectiveness of the protection mechanism to be tested further includes:
assigning technical difficulties for multiple ones of the behavioral traces, and evaluating a level of the protection mechanism to be tested according to the technical difficulty corresponding to the abnormal event detected by the protection mechanism to be tested.

11. A verification system for an information and communication security protection mechanism, the verification system comprising:
a target machine having a protection mechanism to be tested deployed therewith, wherein the target machine is configured to verify a target malicious program that is selected, and the target malicious program corresponds to at least one behavioral trace;
wherein the target machine is configured to reproduce the at least one behavioral trace and to determine whether or not the protection mechanism to be tested detects an abnormal event, so as to verify an effectiveness of the protection mechanism to be tested.

12. The verification system according to claim 11, wherein, according to a location of the at least one behavioral trace, the at least one behavioral trace is classified into a memory trace, a file system trace, or a network connection trace.

13. The verification system according to claim 12, wherein the target machine is a first computer apparatus configured to execute a first test program to reproduce the at least one behavioral trace.

14. The verification system according to claim 13, wherein, in response to the target machine being configured to reproduce the at least one behavioral trace, the first computer apparatus is configured to execute the first test program to modify a computer memory or a computer file system of the first computer apparatus according to the type of the at least one behavioral trace, or imitate the network connection trace by a network interface of the first computer apparatus.

15. The verification system according to claim 14, wherein, when modifying the computer memory of the target machine, the first computer apparatus is configured to execute the first test program to allocate a memory section according to the at least one behavioral trace and a location of the at least one behavioral trace, and insert strings corresponding to the at least one behavioral trace in the memory section.

16. The verification system according to claim 12, wherein the target machine is a virtual machine deployed by executing a virtual machine file through a second computer apparatus, and in response to the target machine being configured to reproduce the at least one behavioral trace, the virtual machine file is further modified in an offline state of the virtual machine to reproduce the at least one behavioral trace.

17. The verification system according to claim 16, wherein the virtual machine is deployed to include a virtual memory and a virtual file system, and the virtual machine file includes a memory portion associated with the virtual memory and a file system portion associated with the virtual file system.

18. The verification system according to claim 17, wherein, in response to the target machine being configured to reproduce the at least one behavioral trace, the second computer apparatus is further configured to:
according to the type of the at least one behavioral trace, modify the memory portion or the file system portion of the virtual machine file in the offline state of the virtual machine, or execute a test program in a deployed state of the virtual machine to imitate the network connection trace through a virtual network interface of the virtual machine.

19. The verification system according to claim 11, wherein the protection mechanism to be tested is an endpoint protection apparatus, a firewall, or an email protection apparatus, and the endpoint protection apparatus is set inside the target machine, the firewall is set outside the target machine, and the email protection apparatus is set outside the target machine.

20. The verification system according to claim 11, wherein a number of the at least one behavioral trace is plural, multiple ones of the behavioral traces correspond to a plurality of technical difficulties, and the technical difficulty corresponding to the abnormal event detected by the protection mechanism to be tested is used to evaluate a level of the protection mechanism to be tested when verifying the effectiveness of the protection mechanism to be tested.
